(19) United States
(12) Patent Application Publication
(10) Pub. No.: US 2015/0042762 A1
(43) Pub. Date: Feb. 12, 2015

(54) APPARATUS AND METHOD FOR MAKING SPECIAL EFFECTS MAKEUP MASK

(71) Applicant: Electronics and Telecommunications Research Institute, Daejeon (KR)

(72) Inventors: Jinseo KIM, Daejeon (KR); Soonyoung KWON, Daejeon (KR); Insu JANG, Daejeon (KR); Juyeon YOU, Daejeon (KR); Yoonseok CHOI, Daejeon (KR); Jihyung LEE, Daejeon (KR); Jaewoo KIM, Daejeon (KR); Songwoo LEE, Daejeon (KR)

(73) Assignee: Electronics and Telecommunications Research Institute, Daejeon (KR)

(21) Appl. No.: 14/189,992

(22) Filed: Feb. 25, 2014

(30) Foreign Application Priority Data
Aug. 12, 2013 (KR) 10-2013-0095399

(51) Int. Cl. G06K 9/00; H04N 13/02

(52) U.S. Cl. CPC G06K 9/00362; H04N 13/0239
USPC 348/47

(57) ABSTRACT

Disclosed are an apparatus and method for making a special effects makeup mask, which can overcome discomfort and resistance to the use of plaster while maintaining the precision of making existing special effects makeup masks. The apparatus includes a 3D model creation unit for creating a 3D face model based on captured face images, and creating a 3D special effects makeup face model based on the 3D face model. A 3D mold part output unit outputs a mold part of the 3D face model and a mold part of the 3D special effects makeup face model corresponding to the 3D face model and the 3D special effects makeup face model, respectively. A special effects makeup mask making unit makes a special effects makeup mask using the mold part of the 3D face model and the mold part of the 3D special effects makeup face model.

### CROSS REFERENCE TO RELATED APPLICATION

This application claims the benefit of Korean Patent Application No. 10-2013-0095399 filed on Aug. 12, 2013, which is hereby incorporated by reference in its entirety into this application.

### BACKGROUND OF THE INVENTION

1. Technical Field

The present invention relates generally to an apparatus and method for making a special effects makeup mask and, more particularly, to an apparatus and method for making a special effects makeup mask, which make a mask used for special effects makeup using a mold.

2. Description of the Related Art

Special effects makeup used in movies such as “Avatar” and “the Fox with Nine Tails” is configured to create a final special effects makeup mask via a procedure for forming a mold using a material such as plaster for the face of an actor, filling the formed mold with a special effects makeup material such as silicone, and hardening the silicone.

Since such a special effects makeup mask made in this way matches 100% the facial shape of an actor, the mask is smoothly fitted to the actor's face without inconvenience during a procedure for applying the mask to the actor's face.

However, when a special effects makeup mask for the entire face such as a mask is made, a procedure for applying plaster to the entire face of an actor and hardening the plaster is required. Such a procedure is so uncomfortable that many actors cannot endure pain caused by the procedure depending on the respective characteristics of actors, but the procedure has still been conducted.

Related prior technology includes technology disclosed in Korean Patent No. 0961679 (entitled “Method of manufacturing prostheses for plastic surgeries on retracted parts using liquid silicone”), which creates a model by directly and actually measuring a retracted part of the whole body of a patient using Liquid Silicone Rubber (LSR), and precisely fits the model to the retracted part (affected part) of the patient, thus enabling an operation to be performed on the affected part in a customized manner.

The invention disclosed in Korean Patent No. 0961679 is configured to form a mold using a plaster model for the retracted part of a patient and manufacture prosthesis using silicone. Since this invention uses a traditional scheme for exploiting a plaster model to manufacture prosthesis, it may cause discomfort to a patient.

Another related prior art technology includes technology disclosed in Korean Patent No. 0494134 (entitled “Method of making a facial mask for beauty treatments”), which makes a face model using plaster so as to check facial changes of women before and after beauty treatments.

The invention disclosed in Korean Patent No. 0494134 uses a traditional scheme for exploiting a plaster model so as to make a facial mask, thus causing discomfort to a person undergoing treatment.

### SUMMARY OF THE INVENTION

Accordingly, the present invention has been made keeping in mind the above problems occurring in the prior art, and an object of the present invention is to provide an apparatus and method for making a special effects makeup mask, which can overcome discomfort and resistance to the use of plaster while maintaining the precision of making existing special effects makeup masks.

In accordance with an aspect of the present invention to accomplish the above object, there is provided an apparatus for making a special effects makeup mask, including a three-dimensional (3D) model creation unit for creating a 3D face model based on captured face images, and creating a 3D special effects makeup face model based on the 3D face model; a 3D mold part output unit for outputting, based on the 3D face model and the 3D special effects makeup face model, a mold part of the 3D face model and a mold part of the 3D special effects makeup face model corresponding to the 3D face model and the 3D special effects makeup face model, respectively; and a special effects makeup mask making unit for making a special effects makeup mask using the mold part of the 3D face model and the mold part of the 3D special effects makeup face model.

Preferably, the 3D model creation unit may include a face capturing unit for capturing images of a face using a plurality of cameras installed at different locations; a 3D face model creation unit for creating the 3D face model based on the face images captured by the face capturing unit; and a design unit for creating the 3D special effects makeup face model based on an appearance of the 3D face model.

Preferably, the 3D model creation unit may further include a 3D face model editing unit for correcting the 3D face model created by the 3D face model creation unit.

Preferably, the 3D mold part output unit may include a data conversion unit for converting data structures of the 3D face model and the 3D special effects makeup face model; and an output unit for outputting the mold part of the 3D face model and the mold part of the 3D special effects makeup face model based on data of the 3D face model and data of the 3D special effects makeup face model output from the data conversion unit.

Preferably, the special effects makeup mask making unit may form the special effects makeup mask by injecting a material for special effects makeup into a mold formed by assembling the mold part of the 3D face model and the mold part of the 3D special effects makeup face model.

Preferably, the mold part of the 3D face model may be configured in a relief mold pattern and the mold part of the 3D special effects makeup face model may be configured in an intaglio mold pattern.

In accordance with another aspect of the present invention to accomplish the above object, there is provided a method of making a special effects makeup mask, including creating, by a three-dimensional (3D) model creation unit, a 3D face model based on captured face images, and creating a 3D special effects makeup face model based on the 3D face model; outputting, by a 3D mold part output unit, a mold part of the 3D face model and a mold part of the 3D special effects makeup face model corresponding to the 3D face model and the 3D special effects makeup face model, respectively, based on the 3D face model and the 3D special effects makeup face model; and making, by a special effects makeup mask making unit, a special effects makeup mask using the mold part of the 3D face model and the mold part of the 3D special effects makeup face model.

Preferably, creating the 3D face model and the 3D special effects makeup face model may include capturing images of a face using a plurality of cameras installed at different locations; creating the 3D face model based on the captured face images; and creating the 3D special effects makeup face model based on an appearance of the 3D face model.

Preferably, creating the 3D face model and the 3D special effects makeup face model may further include correcting the 3D face model between creation of the 3D face model and creation of the 3D special effects makeup face model.

Preferably, outputting the mold part of the 3D face model and the mold part of the 3D special effects makeup face model may include converting data structures of the 3D face model and the 3D special effects makeup face model; and outputting the mold part of the 3D face model and the mold part of the 3D special effects makeup face model based on data of the 3D face model and data of the 3D special effects makeup face model generated at converting the data structures.

Preferably, making the special effects makeup mask may include assembling the mold part of the 3D face model and the mold part of the 3D special effects makeup face model; and forming the special effects makeup mask by injecting a material for special effects makeup into a mold formed at assembling the mold parts.

Preferably, the mold part of the 3D face model may be configured in a relief mold pattern and the mold part of the 3D special effects makeup face model may be configured in an integlio mold pattern.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram of an apparatus for making a special effects makeup mask according to an embodiment of the present invention;

FIG. 2 is a flowchart showing a method for making a special effects makeup mask according to an embodiment of the present invention; and

FIGS. 3 to 6 are diagrams employed in the description of an embodiment of the present invention.

FIG. 7 is an embodiment of the present invention implemented in a computer system.

### DESCRIPTION OF THE PREFERRED EMBODIMENTS

The present invention can be changed in various manners and can have various embodiments, wherein specific embodiments will be illustrated in the attached drawings and will be described in detail below.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted so as to easily understand the entirety of the present invention.

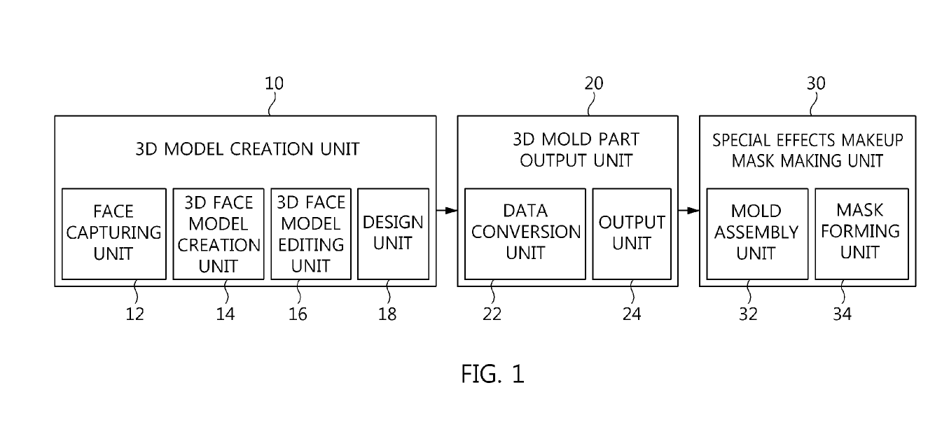

FIG. 1 is a configuration diagram of an apparatus for making a special effects makeup mask according to an embodiment of the present invention.

The apparatus for making a special effects makeup mask according to the embodiment of the present invention includes a three-dimensional (3D) model creation unit 10, a 3D mold part output unit 20, and a special effects makeup mask making unit 30.

The 3D model creation unit 10 creates a 3D face model based on captured face images, and creates a 3D special effects makeup face model based on the created 3D face model.

The 3D model creation unit 10 includes a face capturing unit 12, a 3D face model creation unit 14, a 3D face model editing unit 16, and a design unit 18.

The face capturing unit 12 acquires various face images by capturing images of the face of a user (that is, a person requiring a special effects makeup mask), such as a profile view or a frontal view, using a plurality of digital cameras installed to capture images of the user's face from various angles.

The 3D face model creation unit 14 creates a 3D face model based on the various face images acquired by the face capturing unit 12. In this case, methods of creating a 3D face model based on various face images may be easily understood by those skilled in the art from well-known technology (for example, a typical 3D face modeling technique).

The 3D face model editing unit 16 corrects the 3D face model created by the 3D face model creation unit 14. The 3D face model creation unit 14 may create a plurality of models having different qualities depending on the performance of an algorithm to be applied and capturing conditions. Since the 3D face models created in this way may occasionally not be identical to the actual facial shape of a captured person, the 3D face model editing unit 16 performs the task of correcting the quality of a 3D face model so that the 3D face model exactly matches the actual face of a person.

Of course, if there is no portion to be corrected in the 3D face model output from the 3D face model creation unit 14, the 3D face model editing unit 16 may immediately transfer the 3D face model to the design unit 18 without performing a separate correction task.

The design unit 18 designs a 3D special effects makeup face model (including a shape hiding the whole area of the face like a mask, a shape replacing only a part of the face such as a nose or ears, and other shapes) based on the appearance of the 3D face model output from the 3D face model editing unit 16. For example, when the appearance of the 3D face model is represented in the form of a relief pattern, the 3D special effects makeup face model may be represented in a form obtained by shaping the appearance of the 3D face model (for example, in an intaglio pattern shape) without change.

The 3D mold part output unit 20 outputs, based on the 3D face model and the 3D special effects makeup face model created by the 3D model creation unit 10, the mold part of the 3D face model and the mold part of the 3D special effects makeup face model, which correspond to the 3D face model and 3D special effects makeup face model, respectively.

The 3D mold part output unit 20 includes a data conversion unit 22 and an output unit 24.

The data conversion unit 22 converts the data structures of the 3D face model and the 3D special effects makeup face model. In order to output the 3D face model and the 3D special effects makeup face model, the data of the 3D face model and the data of the 3D special effects makeup face model must be converted into data structures having a format usable in a 3D printer. The data conversion unit 22 performs such a data conversion task. Here, the 3D printer may be the corresponding apparatus (that is, the apparatus for making a special effects makeup mask).

The output unit 24 outputs the mold part of the 3D face model and the mold part of the 3D special effects makeup face model, based on the data of the 3D face model and the 3D special effects makeup face model output from the data conversion unit 22. Here, the mold part of the 3D face model may be configured in a relief mold pattern, and the mold part of the 3D special effects makeup face model may be configured in an intaglio mold pattern opposite to that of the 3D face model. Of course, depending on the circumstances, the mold part of the 3D face model may be configured in an intaglio mold pattern and the mold part of the 3D special effects makeup face model may be configured in a relief mold pattern.

The special effects makeup mask making unit 30 makes a special effects makeup mask using the mold parts of the 3D face model and the 3D special effects makeup face model output from the 3D mold part output unit 20.

The special effects makeup mask making unit 30 includes a mold assembly unit 32 and a mask forming unit 34.

The mold assembly unit 32 forms a mold by assembling the mold part of the 3D face model and the mold part of the 3D special effects makeup face model. That is, the mold parts of the 3D face model and the 3D special effects makeup face model are assembled so that the relief pattern of the mold part of the 3D face model and the intaglio pattern of the mold part of the 3D special effects makeup face model are facing each other while maintaining a gap between the relief pattern and the intaglio pattern.

The mask forming unit 34 forms a desired special effects makeup mask by injecting a material for special effects makeup (for example, silicone or the like) into the mold.

The above-described special effects makeup mask making apparatus shown in FIG. 1 may be understood as being the 3D printer itself, or as being contained in the 3D printer.

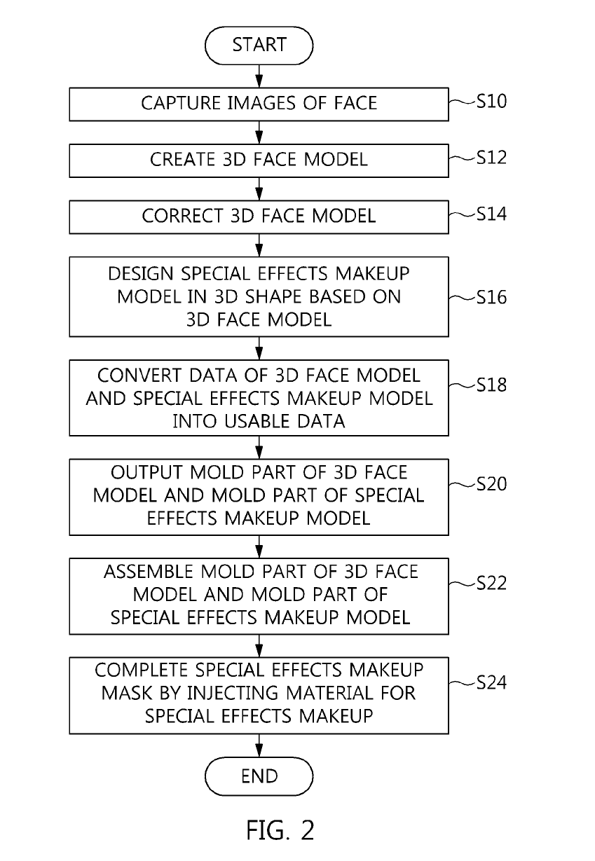

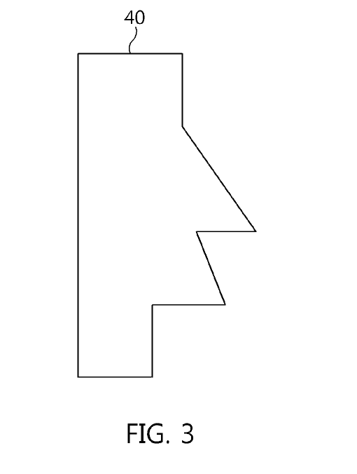

FIG. 2 is a flowchart showing a method of making a special effects makeup mask according to an embodiment of the present invention, and FIGS. 3 to 6 are diagrams employed in the description of the embodiment of the present invention.

A task to be performed first so as to make a special effects makeup mask is to create a 3D model of a user's face, and such a task is performed by the 3D model creation unit 10.

First, the face capturing unit 12 of the 3D model creation unit 10 captures images of the user's face, such as the profile view or the frontal view of the user's face, using two or more digital cameras at step S10.

The face images captured by the face capturing unit 12 are input to the 3D face model creation unit 14. The 3D face model creation unit 14 creates a 3D face model from the two or more face images captured from various angles by using a multi-stereo-based 3D face model creation method at step S12. As the 3D face model created at this step, various models having different qualities may be created depending on the performance of an algorithm to be applied and capturing conditions. The 3D face model created in this way may not be identical to the shape of the actual face of a captured person depending on circumstances.

Accordingly, the 3D face model editing unit 16 performs the task of correcting the quality of the 3D face model so that the 3D face model exactly matches the actual face of the person at step S14. The 3D face model editing unit 16 performs the task of smoothening the irregular surface of the 3D face model and the automatic or semiautomatic correction task of comparing the 3D face model with the actual face of the person and correcting a mismatch portion therebetween.

Then, the design unit 18 performs the task of designing a special effects makeup face model (that is, including a shape hiding the whole area of the face like a mask and a shape replacing only a part of the face such as a nose or ears) in a 3D shape based on the appearance of the 3D face model corrected by the 3D face model editing unit 16 at step S16. Here, for the design of the special effects makeup face model, a method of creating a 3D special effects makeup face model in a desired shape using existing commercial 3D editing software may be used, or a method of creating a 3D model by applying an actual object model to the face capturing unit 12 may be used, and other various types of methods of creating 3D models may be used.

In this way, in order to output the data of the 3D face model and the 3D special effects makeup face model created by the 3D model creation unit 10 via the 3D printer, the model data must be converted into data having a format usable in the 3D printer.

Accordingly, a task that must be performed first by the 3D mold part output unit 20 so as to output the 3D face model and the 3D special effects makeup face model is to convert the data structures of the 3D face model and the 3D special effects makeup face model output from the 3D model creation unit 10 into data having a format usable in the 3D printer. That is, the data conversion unit 22 of the 3D mold part output unit 20 performs such a data conversion task at step S18.

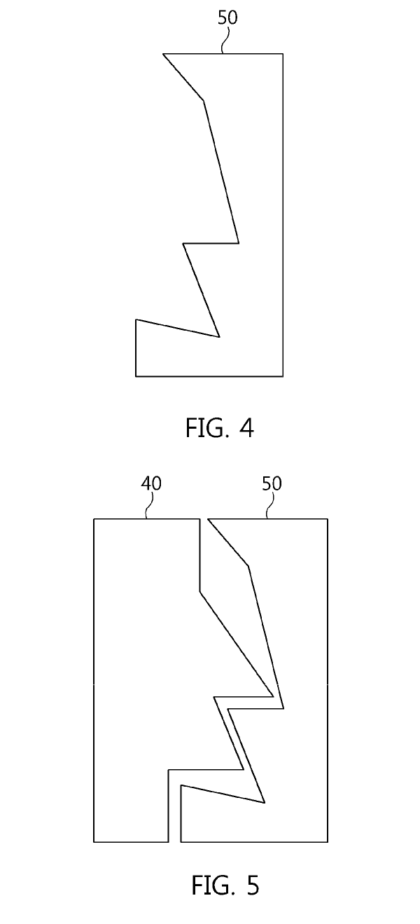

The 3D face model and the 3D special effects makeup face model, the data structures of which have been converted by the data conversion unit 22, are input to the output unit 24, and the output unit 24 outputs 3D mold parts required to make a special effects makeup mask at step S20. For example, the output unit 24 may output the 3D mold parts such as those illustrated in FIGS. 3 and 4. FIG. 3 illustrates an example of the 3D mold part 40 of the 3D face model, and FIG. 4 illustrates an example of the 3D mold part 50 of the 3D special effects makeup face model.

As described above, when the 3D mold parts of the 3D face model and the 3D special effects makeup face model are respectively output, the mold assembly unit 32 of the special effects makeup mask making unit 30 assembles the 3D mold part of the 3D face model and the 3D mold part of the 3D special effects makeup face model, thus completing a mold at step S22. Here, the assembled mold has a shape illustrated in FIG. 5.

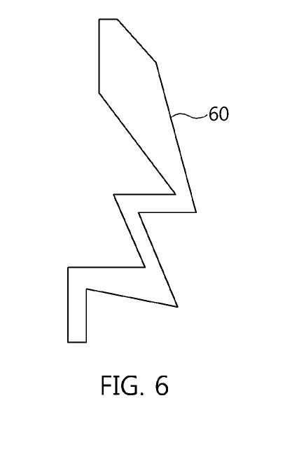

Finally, the mask forming unit 34 of the special effects makeup mask making unit 30 forms a final special effects makeup mask by injecting a material for special effects makeup such as silicone into the mold. That is, if the material for special effects makeup such as silicone is injected into an empty space between the 3D mold part 40 of the 3D face model and the 3D mold part 50 of the 3D special effects makeup face model illustrated in FIG. 5 and is then hardened, a special effects makeup mask 60 such as that illustrated in FIG. 6 is completed at step S24. That is, in FIG. 6, a left part of the drawing appears as being identical to the contour of an actual user's face (for example, an actor), and a right part thereof represents a face for special effects makeup.

Since the special effects makeup mask 60 made using the above-described method has a shape identical to the facial shape of a person, it comes into close contact with the skin of the person's face and is exactly fitted to the skin of the face, thus improving the realism of the mask. In addition to the field of special effects makeup, models having appearance identical to actual shapes are provided to persons having facial deformities in nose, ears, or lips, and thus an inexpensive and easy replacement means may be provided to persons who feel resistance to painful, time-consuming and high-cost plastic surgeries.

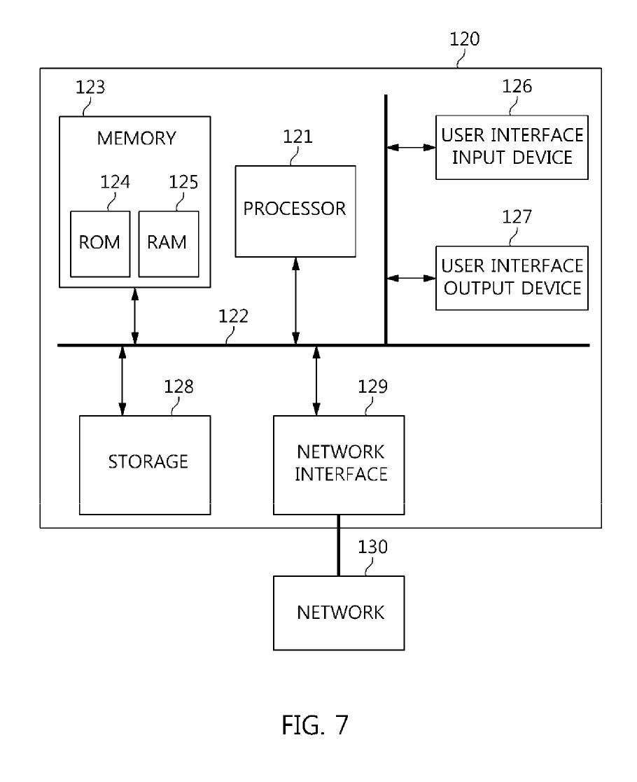

FIG. 7 is an embodiment of the present invention implemented in a computer system.

Referring to FIG. 7, an embodiment of the present invention may be implemented in a computer system, e.g., as a computer readable medium. As shown in in FIG. 7, a computer system 120 may include one or more of a processor 121, a memory 123, a user input device 126, a user output device 127, and a storage 128, each of which communicates through a bus 122. The computer system 120 may also include a network interface 129 that is coupled to a network 130. The processor 121 may be a central processing unit (CPU) or a semiconductor device that executes processing instructions stored in the memory 123 and/or the storage 128. The memory 123 and the storage 128 may include various forms of volatile or non-volatile storage media. For example, the memory may include a read-only memory (ROM) 124 and a random access memory (RAM) 125.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

In accordance with the present invention having the above configuration, a 3D model mold exactly matching the actual face of a person is output using a 3D printer, and a silicone mask to be used for actual special effects makeup is produced using the output 3D model mold and is applied to makeup, thus solving inconvenience and resistance felt when existing molds are made using plaster.

Furthermore, the technology of the present invention may also be used in the production of prostheses identical to actual facial features of persons having lost facial parts to replace them, as well as the use in making special effects makeup masks.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for making a special effects makeup mask, comprising:
a three-dimensional (3D) model creation unit for creating a 3D face model based on captured face images, and creating a 3D special effects makeup face model based on the 3D face model;
a 3D mold part output unit for outputting, based on the 3D face model and the 3D special effects makeup face model, a mold part of the 3D face model and a mold part of the 3D special effects makeup face model corresponding to the 3D face model and the 3D special effects makeup face model, respectively; and
a special effects makeup mask making unit for making a special effects makeup mask using the mold part of the 3D face model and the mold part of the 3D special effects makeup face model.

2. The apparatus of claim 1, wherein the 3D model creation unit comprises:
a face capturing unit for capturing images of a face using a plurality of cameras installed at different locations;
a 3D face model creation unit for creating the 3D face model based on the face images captured by the face capturing unit; and
a design unit for creating the 3D special effects makeup face model based on an appearance of the 3D face model.

3. The apparatus of claim 2, wherein the 3D model creation unit further comprises a 3D face model editing unit for correcting the 3D face model created by the 3D face model creation unit.

4. The apparatus of claim 1, wherein the 3D mold part output unit comprises:
a data conversion unit for converting data structures of the 3D face model and the 3D special effects makeup face model; and
an output unit for outputting the mold part of the 3D face model and the mold part of the 3D special effects makeup face model based on data of the 3D face model and data of the 3D special effects makeup face model output from the data conversion unit.

5. The apparatus of claim 1, wherein the special effects makeup mask making unit forms the special effects makeup mask by injecting a material for special effects makeup into a mold formed by assembling the mold part of the 3D face model and the mold part of the 3D special effects makeup face model.

6. The apparatus of claim 1, wherein the mold part of the 3D face model is configured in a relief mold pattern and the mold part of the 3D special effects makeup face model is configured in an intaglio mold pattern.

7. A method of making a special effects makeup mask, comprising:
creating, by a three-dimensional (3D) model creation unit, a 3D face model based on captured face images, and creating a 3D special effects makeup face model based on the 3D face model;
outputting, by a 3D mold part output unit, a mold part of the 3D face model and a mold part of the 3D special effects makeup face model corresponding to the 3D face model and the 3D special effects makeup face model, respectively, based on the 3D face model and the 3D special effects makeup face model; and
making, by a special effects makeup mask making unit, a special effects makeup mask using the mold part of the 3D face model and the mold part of the 3D special effects makeup face model.

8. The method of claim 7, wherein creating the 3D face model and the 3D special effects makeup face model comprises:
capturing images of a face using a plurality of cameras installed at different locations;
creating the 3D face model based on the captured face images; and
creating the 3D special effects makeup face model based on an appearance of the 3D face model.

9. The method of claim 8, wherein creating the 3D face model and the 3D special effects makeup face model further comprises correcting the 3D face model between creation of the 3D face model and creation of the 3D special effects makeup face model.

10. The method of claim 7, wherein outputting the mold part of the 3D face model and the mold part of the 3D special effects makeup face model comprises:
converting data structures of the 3D face model and the 3D special effects makeup face model; and
outputting the mold part of the 3D face model and the mold part of the 3D special effects makeup face model based on data of the 3D face model and data of the 3D special effects makeup face model generated at converting the data structures.

11. The method of claim 7, wherein making the special effects makeup mask comprises:
assembling the mold part of the 3D face model and the mold part of the 3D special effects makeup face model; and
forming the special effects makeup mask by injecting a material for special effects makeup into a mold formed at assembling the mold parts.

12. The method of claim 7, wherein the mold part of the 3D face model is configured in a relief mold pattern and the mold part of the 3D special effects makeup face model is configured in an intaglio mold pattern.
